(19) United States
(12) Patent Application Publication
(10) Pub. No.: US 2006/0127010 A1
(43) Pub. Date: Jun. 15, 2006

(54) Optical fibers or other waveguide having one or more modeled tap structures for forming desired illumination patterns and method of making the same

(75) Inventor: Susan D. Allen, Tallahassee, FL (US)

Correspondence Address: FLESHNER & KIM, LLP, P.O. BOX 221200, CHANTILLY, VA, 20153, US

(73) Assignee: Arkansas State University

(21) Appl. No.: 11/331,204

(22) Filed: Jan. 13, 2006

Related U.S. Application Data
(62) Division of application No. 09/704,733, filed on Nov. 3, 2000, now abandoned.
(60) Provisional application No. 60/163,292, filed on Nov. 3, 1999.

(51) Int. Cl. G02B 6/26

(52) U.S. Cl. 385/48

(57) ABSTRACT

An apparatus is provided that includes one or more optical fibers or other waveguides for receiving light, and one or more modeled tap structures formed in the one or more optical fibers or waveguides, a desired illumination pattern is created by scattering, reflection and/or refraction of portions of the light through the one or more modeled tap structures formed by using illumination pattern parameters determined by modeling the desired illumination pattern. The illumination pattern can be spherical, cylindrical or conical in shape. The illumination pattern can also be in the shape of an arc. The apparatus can be utilized with one or more light sources. Further, a method is provided of determining illumination patterns resulting from light passing through one or more tap structures on one or more optical fibers or waveguides.

### RELATED APPLICATION(S)

This application is a continuation of U.S. application Ser. No. 09/704,733, filed Nov. 3, 2000, now abandoned, which is hereby incorporated by reference in its entirety.

### BACKGROUND OF THE INVENTION

1. Field of the Invention

The present invention is directed to optical fibers or other waveguides having a plurality of tap structures, as well as an apparatus and a method of fabricating tap structures onto these optical fibers or waveguides arranged to produce illumination patterns for a variety of applications.

2. Background of the Related Art

U.S. Pat. No. 5,500,913 ('913) discloses an apparatus and method of fabricating directional fiber optic taps, sensors and other devices with variable angle output. More particularly, the '913 patent discloses an apparatus and method of micromachining gaussian or v-shaped (triangular) grooves in the cladding of multimode and single mode fibers in order to tap out a small fraction of the light in the fiber. This small fraction of light is used to monitor the optical signals which are being transmitted through the optical fiber from one location to another in fiber optic communications systems.

The above reference is incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

According to the present invention, one or more tap structures are provided in an optical fiber or other waveguide. Parameters, including the number of tap structures, the shape or geometry of the tap structures, the depth of the tap structures and distances between tap structures, are manipulated to produce predetermined illumination, or output patterns for a wide variety of applications. The parameters can be manipulated to produce, for example, generally spherical, cylindrical or conical illumination patterns, or an illumination pattern generally in the shape of an arc. Further, the optical fiber or waveguide can be utilized with one or more light sources. The tap structures can have an asymmetrical geometry structure. The one or more tap structures can also be configured so that a length of the tap structure extending in a longitudinal direction of the optical fiber or waveguide is larger than a width in a radial direction of the optical fiber or waveguide. The one or more tap structures may also extend radially around the optical fiber or waveguide.

According to one embodiment of the invention, an apparatus is provided that comprises one or more optical fibers or other waveguides for receiving light; and a plurality of tap structures formed in the one or more optical fibers or waveguides configured so that, when the light travels through said one or more optical fibers or waveguides, a predetermined pattern is created by scattering, reflection and/or refraction of portions of the light through the one or more tap structures.

According to another embodiment of the invention, an apparatus is provided that comprises one or more optical fibers or other waveguides for receiving light, and a continuous tap structure formed in the one or more optical fibers or waveguides configured so that, when the light travels through the one or more optical fibers or waveguides, a predetermined illumination pattern is created by scattering, reflection and/or refraction of portions of the light through the one or more tap structures.

According to a still further embodiment of the invention, an apparatus is provided that comprises one or more optical fibers or waveguides for receiving light, and one or more tap structures formed in the one or more optical fibers or waveguides configured so that, when the light travels through the one or more optical fibers or waveguides, an amount of the light output through the one or more tap structures is optimized. For example, greater than approximately 90% of the light may be output through the one or more tap structures.

According to yet another embodiment of the invention, an apparatus is provided that comprises one or more photon channeling structures for receiving photons, and a plurality of tap structures formed in one or more photon channeling structures configured so that, when the photons travel through the one or more photon channeling structures, a predetermined pattern is created by scattering, reflection or refraction of portions of the photons through the one or more tap structures.

According to another embodiment of the invention, a method is provided of determining illumination patterns resulting from light passing through one or more tap structures on one or more optical fibers or waveguides comprising selecting illumination pattern parameters for one or more tap structures, geometrically modeling the cross section of each of the one or more tap structures using the illumination parameters, and predicting propagation direction and intensity of the plane waves. The geometrically modeling can comprise geometrically modeling a tap structure using a planar waveguide, or a cylindrical waveguide, or other type waveguides. Further, the method can include determining whether the predetermined illumination pattern has been obtained, adjusting the illumination parameters if the predetermined illumination pattern has not been obtained and then repeating the steps of selecting illumination pattern parameters through the one or more tap structures, geometrically modeling the cross section of each of the one or more tap structures using the illumination parameters, and predicting propagation direction and intensity of the plane waves.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic drawing of an optical fiber according to the invention;

FIG. 2 is a schematic drawing of an optical fiber according to the invention having an arrangement of tap structures configured to emit reflected light;

FIG. 3 is a schematic drawing of an optical fiber according to the invention having an arrangement of tap structures configured to emit refracted light;

FIG. 4 is a schematic drawing of an optical fiber according to the invention having an arrangement of tap structures configured to emit reflective and refractive light and utilizing a back reflective surface within the optical fiber;

FIG. 5A is a schematic drawing of an optical fiber according to the invention having longitudinally extending tap structures;

FIG. 5B is a top view of the optical fiber of FIG. 5A;

FIG. 6 is a schematic drawing of an optical fiber according to the invention that produces a generally spherical illumination pattern;

FIG. 7 is a schematic drawing of an optical fiber according to the invention that produces a generally cylindrical illumination pattern;

FIG. 8 is a schematic drawing of an optical fiber according to the invention that produces an arced illumination pattern;

FIG. 9 is a schematic drawing of an optical fiber having multiple taps that are configured to create a cylindrical illumination pattern;

FIG. 10A is a graph showing the intensity distribution of a portion of the taps of the optical fiber of FIG. 9;

FIG. 10B is a graph showing a summation of the intensities of FIG. 10A;

FIG. 10C is a cross-section view of the graph in FIG. 10B;

FIG. 11 is a schematic drawing of an optical fiber according to the invention using a continuous circular tap structure to produce a generally cylindrical illumination pattern;

FIG. 12A is a flowchart of a process of modeling an illumination pattern according to the invention;

FIG. 12B is a flow chart of an iterative process of modeling an illumination pattern according to the invention;

FIG. 12C is a flow chart of a method for generating tap structures for a particular desired illumination pattern according to the invention;

FIG. 13 is a schematic drawing of an exemplary plant light system according to the invention;

FIG. 14 is a scanning electron micrograph (SEM) of an approximately 100 tap structure;

FIG. 15 is an optical micrograph of a tap structure having a tap angle of approximately 50°;

FIG. 16 is a graph of etch depth and light throughput versus number of scans;

FIG. 17 is a planar tap model used to approximate an output of a single tap structure;

FIGS. 18A and 18B are graphs of spatial output distributions of tap structures having tap angles of approximately 10° and 35°, respectively, with approximately equal etch depths of approximately 20 μm measured with a 10 mW HeNe laser (λ=0.63 μm);

FIG. 19 is a graph of spatial output distribution of a tap structure having a tap angle of approximately 50° for a single mode fiber;

FIG. 20 is a graph of etch depth and throughput versus laser scan for a single mode fiber;

FIG. 21 is a graph of the dependence of output on etch depth for a single mode fiber measured at three different detector positions around the fiber (1=above, 2=side, 3=back);

FIG. 22 is a chart comparing experimental and theoretical results based on the model of FIG. 17;

FIG. 23 is a schematic drawing of another exemplary plant light system according to the invention; and

FIG. 24 is an example of another application of the present invention.

Similar reference numerals refer to similar parts throughout the several views of the drawings.

### DETAILED DESCRIPTION OF PREFERRED EMBODIMENTS

U.S. Pat. No. 5,500,913, which is incorporated herein by reference in its entirety, demonstrates a method of fabricating fiber optic taps with variable angle output. More particularly, the '913 patent taught an apparatus and method of micromachining gaussian or v-shaped (triangular) grooves in the cladding of multimode and single mode fibers in order to tap out a small fraction of the light in the fiber to monitor throughput in fiber optic communications and data processing.

According to the invention, the intensity or illumination pattern of tapped output light of an optical fiber or other waveguide, may be manipulated by using a plurality of tap structures, to allow the optical fiber or other waveguide to be used in a wide variety of illumination applications. The tap structures may be configured using a laser or other fabrication means. As defined herein, illumination pattern parameters include the number of tap structures, the shape or geometry of the tap structures, the depth of the tap structures and distances between tap structures. According to the instant invention, one or more of the illumination parameters are selected to yield predetermined illumination patterns of the tapped light. It will be further shown that these predetermined illumination patterns can be utilized for a variety of illumination applications. Hence, in contrast to the teachings of U.S. Pat. No. 5,500,913, which monitors optical signals being transmitted in an optical fiber, the present invention utilizes the light output from the tap structures, creates illumination patterns for desired illumination applications by using a plurality of tap structures, and does not involve the transmission of any optical signal to speak of.

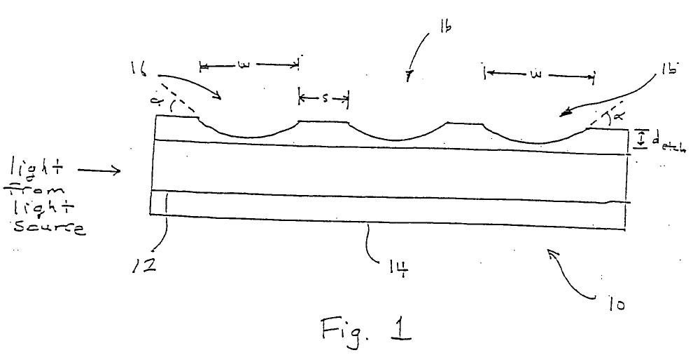

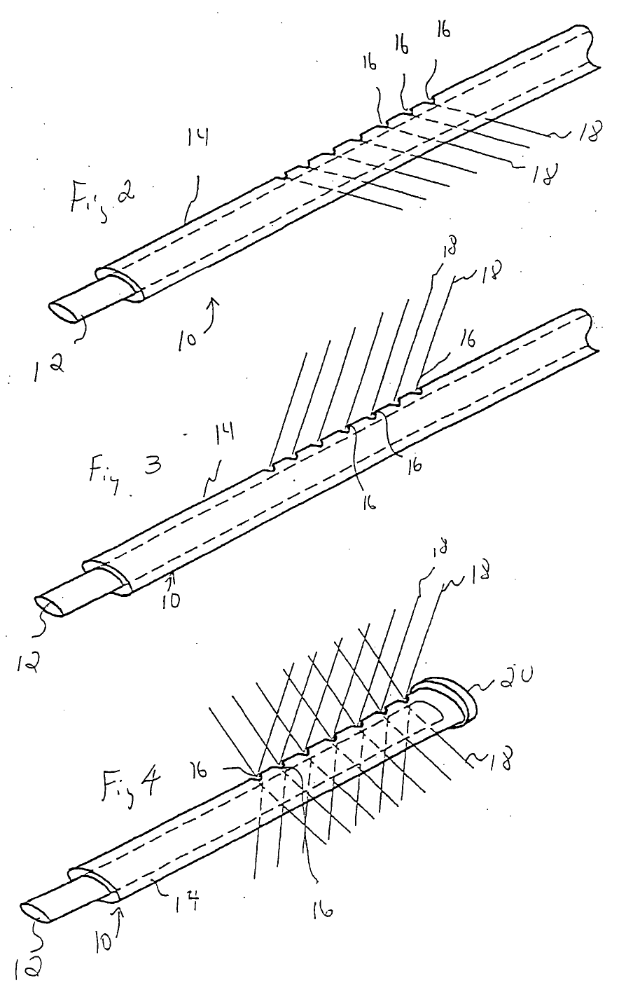

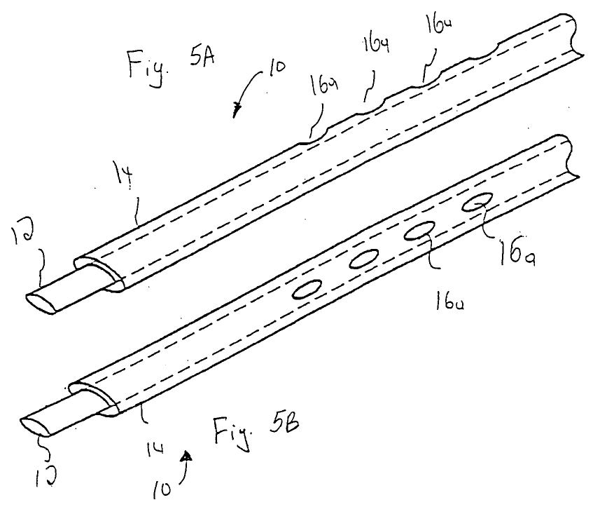

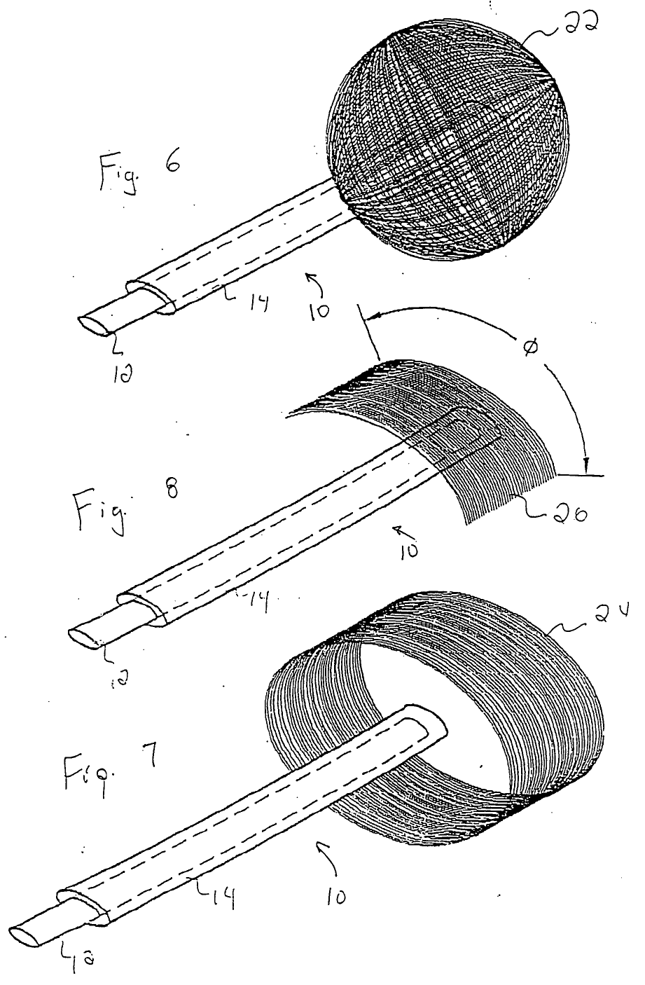

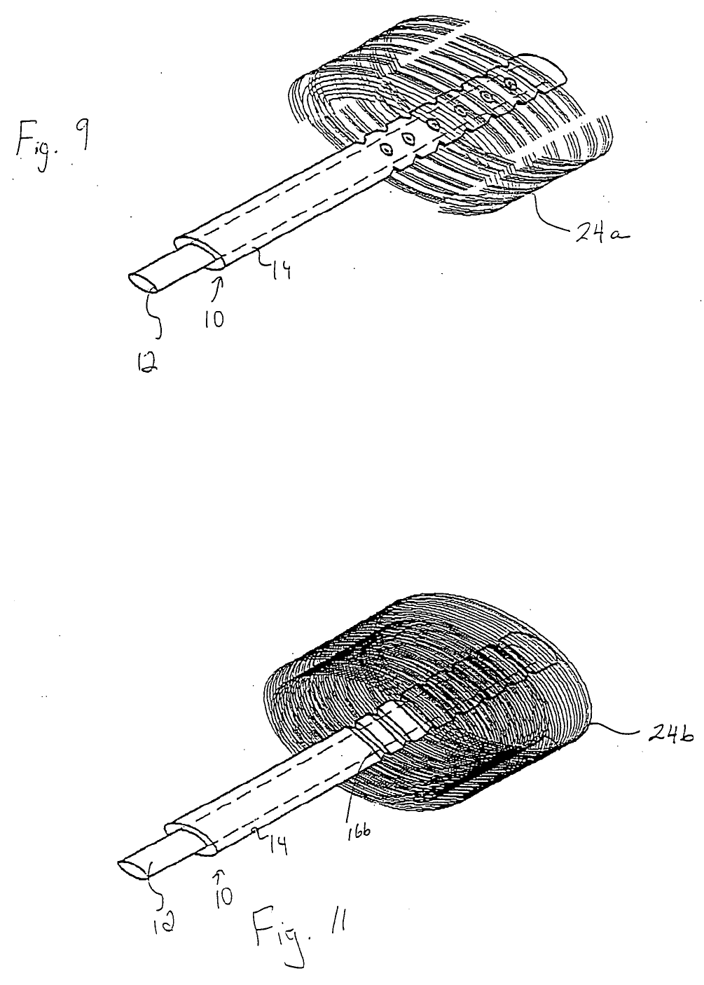

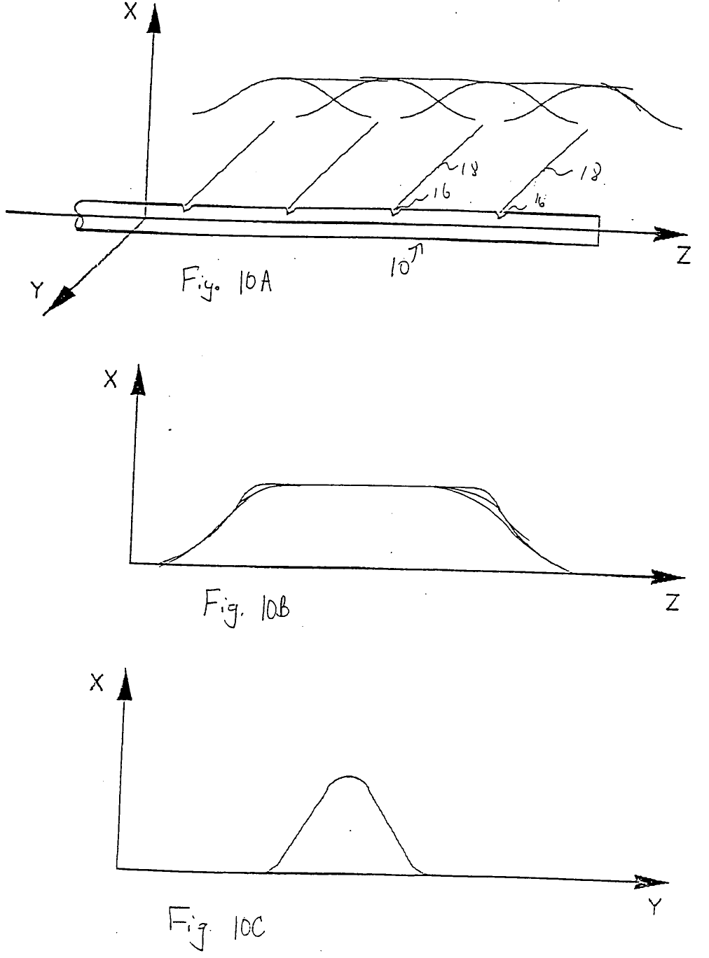

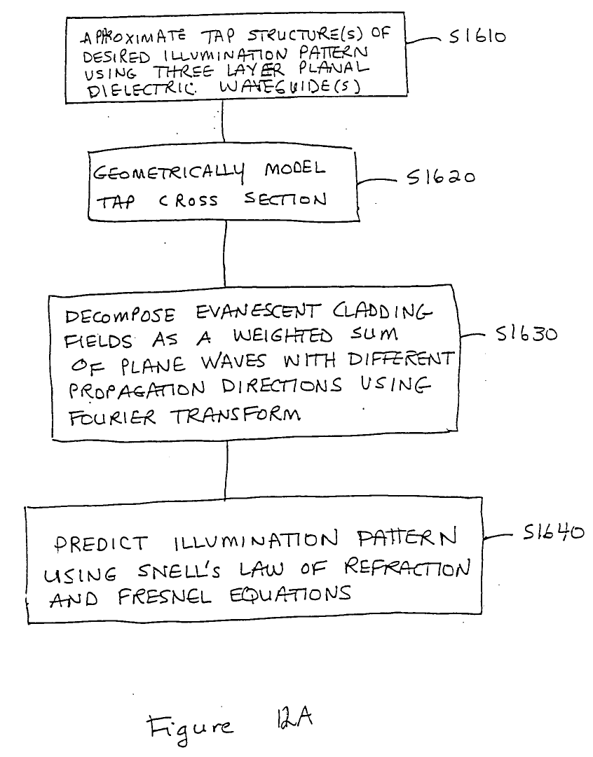

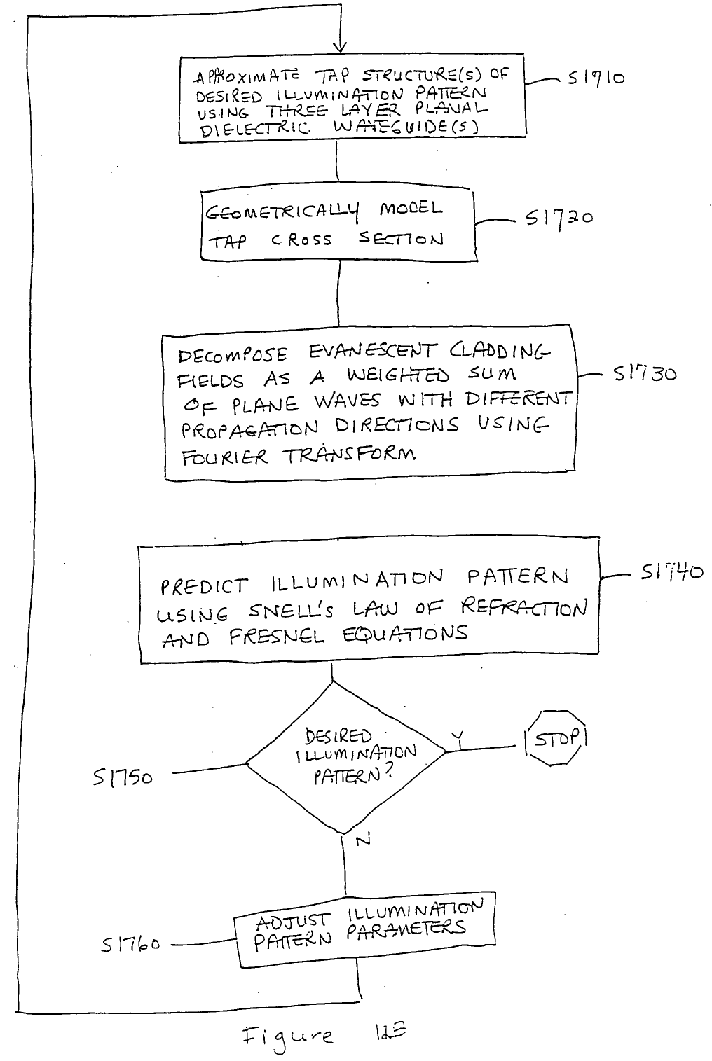

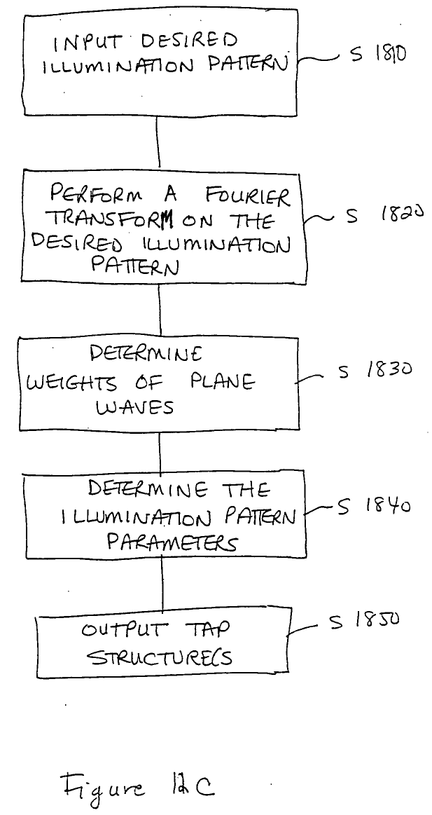

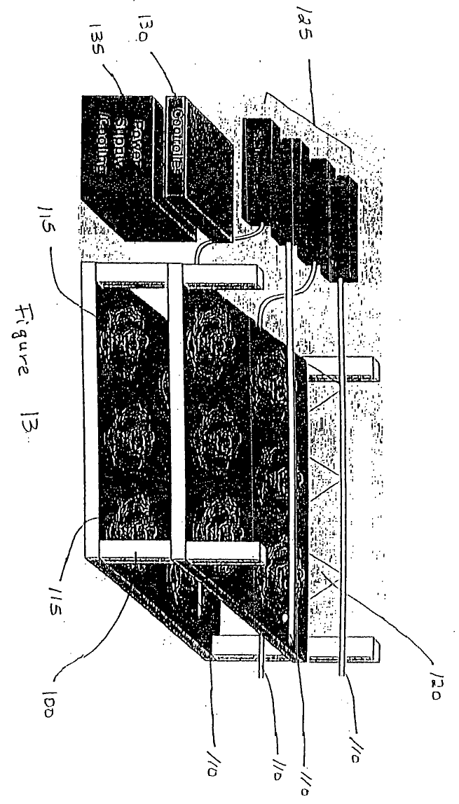

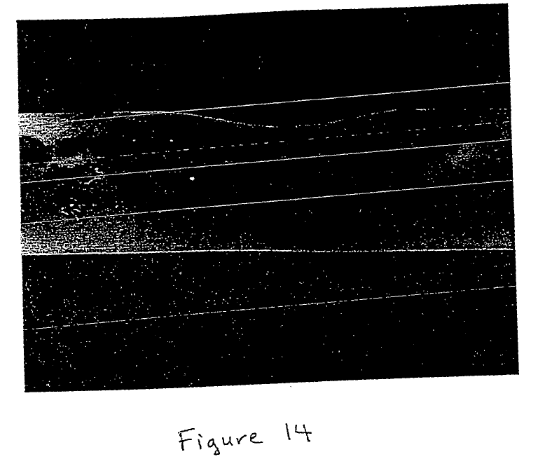

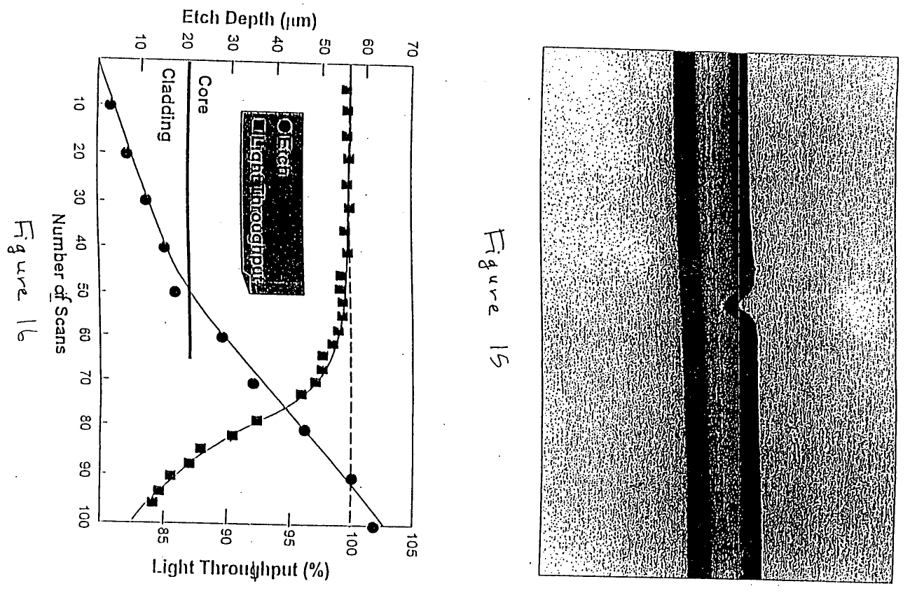

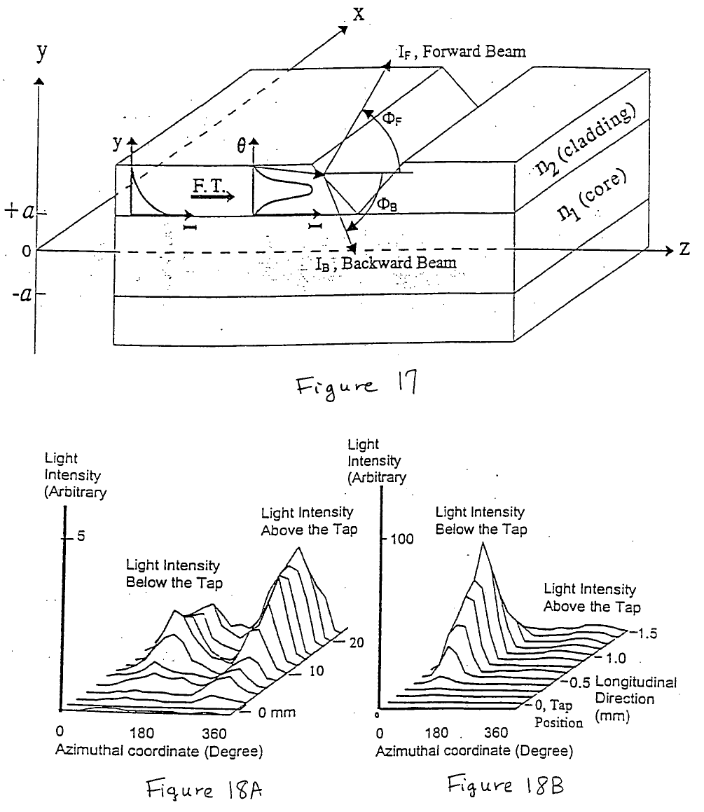

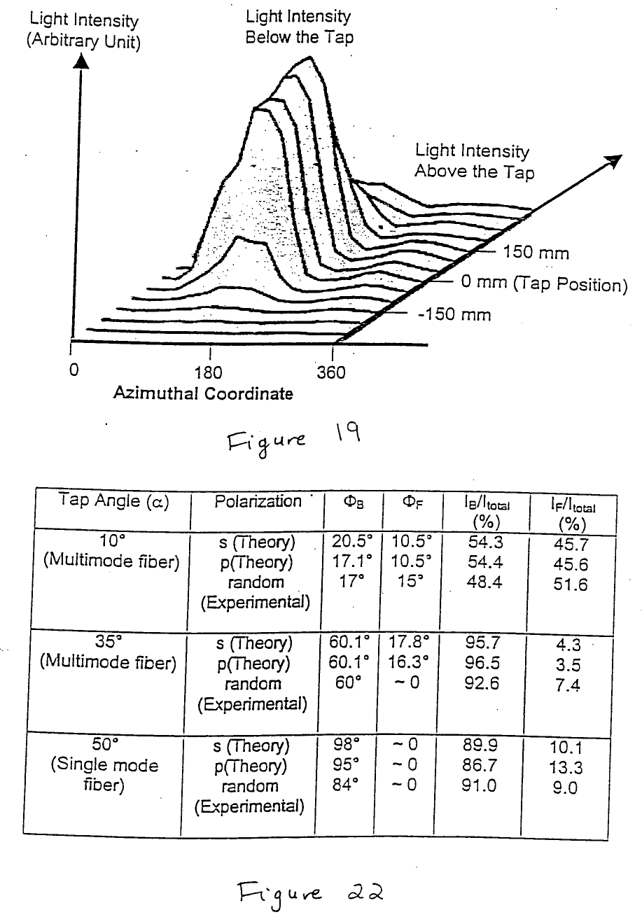

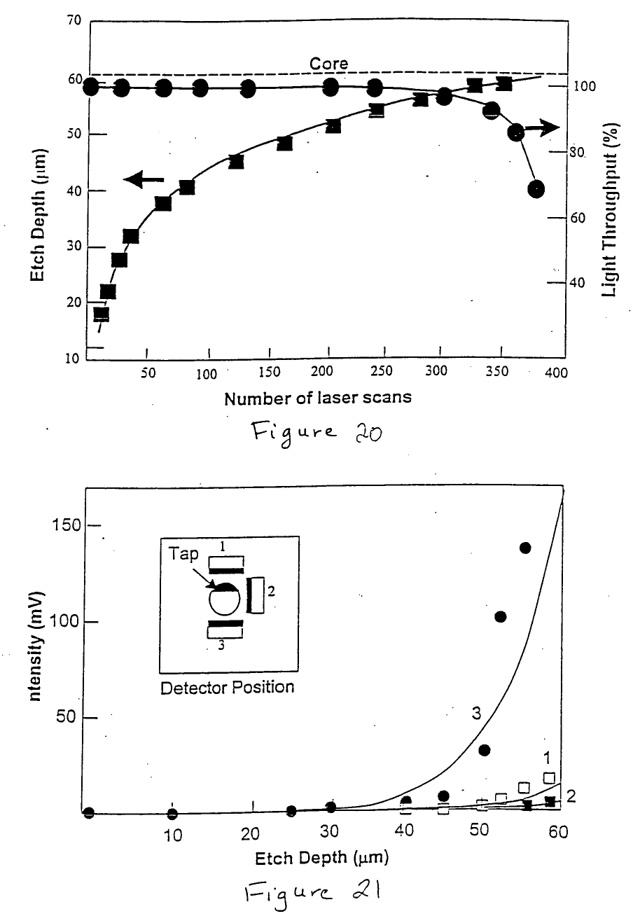

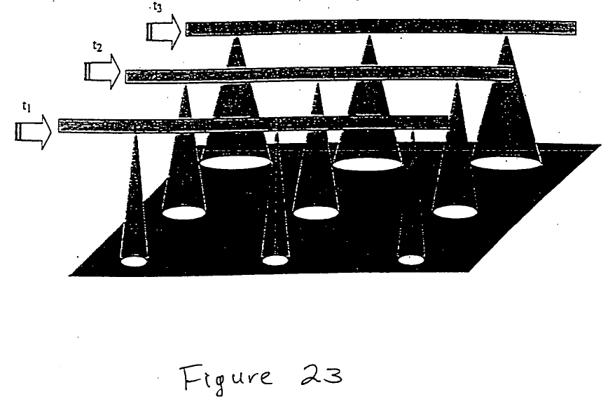

FIG. 1 is a schematic drawing of an optical fiber according to the invention. The optical fiber 10 includes a core 12 and a cladding 14. Throughout this discussion, it should be understood that optical fibers or waveguides may include light guides, light pipes, or any other light or photon channeling structure of any geometry. Please understand that when photons are not light radiation that herein throughout illumination pattern includes a radiation pattern. The tap structures 16 are machined in the cladding 14 and/or the core 12. The optical fibers can be multimode or single mode fibers. The invention is also applicable to graded index fibers.

Individual tap structures 16 each have a particular geometry including a width W, a tap angle a and a depth d_{etch}. The individual tap structures are separated by a distance s. These parameters, along with the number of tap structures, can be manipulated to form predetermined illumination patterns.

For example, the depth d_{etch} of the tap structure is generally proportional to the individual tap structure output. For multimode fibers, it may be necessary to tap into the core of the optic fiber to obtain the desired output. Careful modeling is required to obtain the desired illumination pattern, as will be later discussed.

The optical fiber with tap structure(s) can be utilized with a variety of light sources, which provide, for example, UV light (for applications such as photolithography applications), infrared light and/or visible light, etc., any one of which could be incoherent, coherent or partially coherent light. Some examples of light sources may include lasers, including high power and semiconductor laser diodes (SLDs), and light emitting diodes (LEDs). Other light sources may also be applicable. A particular light source is selected for use with the optical fiber based on the application and the desired illumination pattern.

Some examples of tap structure geometry are shown in FIGS. 2-5B. FIG. 2 is a schematic drawing of an optical fiber 10 having shallow low angle tap structures 16. Shallow low angle tap structures generally generate a largely “refractive” output 18. On the other hand, FIG. 3 is a schematic drawing of an optical fiber 10 having narrower large angle tap structures 16. Narrower large angle taps generally generate largely “reflective”.

Asymmetrical tap structures, such as those shown in FIG. 4, can be fabricated and yield different angular distributions for the emitted output 18. Furthermore, in addition to the transverse trench geometry tap structures illustrated in FIGS. 2 and 3, longitudinally extending tap structures 16a, either relatively narrow or relatively wide, can be fabricated, as shown in FIGS. 5A and 5B. Other types of geometries for the tap structures may also be appropriate. Essentially, tap structures of any geometry relative to the fiber axis may be required to be fabricated depending on the desired illumination pattern.

As seen in FIG. 4, light traveling within the optical fiber 10 can be reflected back using an appropriate reflecting member 20 so that the light travels through the optical fiber bi-directionally. Alternately, a back propagating light beam can be produced by a second light source (not shown).

Further, the tap structures 16 may have an asymmetrical geometry with different angles for the forward and back propagating beams of light. Each tap structure 16 can be configured so as to allow light to escape the tap refractively or reflectively or both refractively and reflectively, in multiple different directions, and at multiple different (or similar) angles. For example, light may escape the tap structures at one angle and direction of escape for a light beam traveling in one direction within the optical fiber 10, and at another angle and direction of escape for a light beam traveling in the opposite direction within the optical fiber 10.

A variety of predetermined illumination patterns may be created according to the invention, and some examples are discussed below. These illumination patterns are created by selecting illumination pattern parameters, such as the number of tap structures, the shape or geometry of the tap structures, the depth of the tap structures and/or distances between tap structures.

FIG. 6 is a schematic drawing of an optical fiber 10 according to the invention that has been tapped to produce a generally spherical illumination pattern 22. The specific tap structures 16 have been omitted from FIG. 6 for clarity purposes. One application of the present invention could be, for example, in photodynamic therapy, wherein relatively uniform low intensity illumination of a structure is required. A spherical light pattern, such as that shown in FIG. 6, may be used, for example, for therapy of the bladder or stomach. Other applications may also be appropriate.

FIG. 7 is a schematic drawing of an optical fiber 10 according to the invention that has been tapped to produce a generally cylindrical illumination pattern 24. Such an illumination pattern could be used, for example, for photodynamic therapies of the esophagus, intestines, atherosclerotic plaque of the arteries, etc., although other uses may also be appropriate. The specific tap structures 16 have been omitted from FIG. 7 for clarity purposes.

FIG. 8 is a schematic drawing of an optical fiber 10 according to the invention that produces an arced illumination pattern 26 with an arc angle φ. The arc angle φ can be any desired arc angle. Such a light pattern 26 could be useful in traffic intersection devices, such as to illuminate a stop sign, as well as other traffic control devices, such as lane shift indicators, runway lighting, etc. As light coupled into or produced within an optical fiber is potentially less expensive, more efficient when compared to LED or conventional lighting, such devices would be relatively less expensive to operate, and more versatile. Other uses could include room lighting, pool lighting, and lighting for controls in a car or the like. Other applications could be to provide light for use for hydroponic plant growth, or for treatment of only a portion of an affected body part in photodynamic therapy, which is discussed in more detail below. The specific tap structures 16 have been omitted from FIG. 8 for clarity purposes.

FIG. 9 shows an optical fiber 10 that has been tapped to produce a cylindrical light pattern 24a. FIG. 10A is a three dimensional graph that illustrates the light intensity distribution for four tap structures 16 of FIG. 9 while FIG. 10B illustrates the summation of the intensities of the tap structures 16 so produced. As each tap 16 contributes an equal light intensity, an appropriate spacing of the tap structures 16 produces a uniform intensity around the tap structure zone. FIG. 10C is a cross-section view of the graph of FIG. 10B.

By extending taps radially around an optical fiber 10, as shown in FIG. 11, a uniform intensity can be produced radially around the optical fiber 10 in order to produce a cylindrical light pattern 24, as shown in FIGS. 7 and 11.

More particularly, FIG. 11 is a schematic drawing of an optical fiber according to the invention that produces a generally cylindrical illumination pattern. This generally cylindrical light pattern 24b is produced by a continuous circular tap structure 16b that extends radially around the optical fiber 10. The tap structure 16b emits light traveling in one direction within the optical fiber 10, as well as light traveling in the opposing direction within the optical fiber 10.

Another application of the present invention could be for pipe inspection. The tap structures on an optical fiber could be configured to produce, for example, a cone shaped illumination pattern. The optical fiber could then be mounted on an adapted conventional spider, which would then be placed in the pipe and moved along the length of the pipe. The light of the illumination pattern would be scattered by the walls of the pipe. That scattered light could be collected and forwarded to a detector or sensor mounted on the spider, or reflected utilizing a mirror or other optic device into the fiber for detection by a sensor located at the source of the fiber outside of the pipe. In this way, irregularities in the pipe could be easily identified.

FIG. 24 is an example of another embodiment of the invention. Optical fiber or waveguide 310 is depicted having an arrangement of tap structures 323 which yields a predetermined illumination pattern 324. In this case, the tap structures 316 are created in a plexiglass waveguide 310. As can be seen, in this case there are two light sources 317a and 317b. In addition, in this case there are two internal reflective surfaces 375a and 375b which reflect portions of light 317a and 317b, respectively, in order to optimize the illumination pattern 324. It should be noted that if a single light source is used, such as 317a or 317b, then an additional facet or surface could be made reflective, namely internal surface 375c.

The invention may also be applicable to other sensing devices, including devices that sense and gather light. Further, it can be used in other situations which require sensing or illumination of hard to reach areas.

### Process for Determining Illumination Pattern Parameters to Yield an Illumination Pattern

A three layer planar dielectric waveguide is used as shown in FIG. 17 to approximate a tap structure. The tap cross section was modeled by an isosceles triangle in the outer layer of the planar dielectric waveguide. It should be noted that the modeling could be accomplished using cylindrical or asymmetric or other waveguide models depending on the tap structure shape. The exponentially decaying evanescent cladding fields that are directly affected by the triangular shaped tap structure, are used to predict the form and energy distribution of the tap output. These cladding fields are decomposed as a weighted sum of the plane waves with different propagation directions using a Fourier transform. Traditional ray tracing methods are then used to predict the propagation of the light out of the fiber. In this method, Snell's law of refraction and the Fresnel equations for reflection at dielectric interfaces yield the propagation direction and the intensity of the plane waves transmitted and reflected at the tap facet.

The theoretical predictions of this model and the corresponding experimental results are compared in FIG. 22, where the parameters are defined in FIG. 17. By changing the angle of the tap, greater than 90% of the tap output in these initial, unoptimized experiments can be directed out of the fiber in a beam below the tap. Thus, the present invention optimizes tap structure output efficiency.

FIG. 12A is a flowchart of a process of modeling an illumination pattern according to the invention. First, the three layer planar dielectric waveguide, discussed above, is used to approximate tap structure(s) of the desired illumination pattern (step S1610). The cross sections of the tap structure(s) are then modeled using an isosceles triangle in the outer layer of the planar dielectric waveguide (step S1620). The exponentially decaying evanescent cladding fields that are directly affected by the triangular shaped tap structure(s) are used to predict the form and energy distribution of the output of the tap structure(s). These cladding fields are decomposed as a weighted sum of the plane waves with different propagation directions using a Fourier transform (step S1630). The traditional ray tracing method is then used to predict the propagation of the light out of the fiber. In this method, Snell's law of refraction and the Fresnel equations for reflection at dielectric interfaces yield the propagation direction and the intensity of the plane waves transmitted and reflected at the tap structure facet(s) (step S1640). It was found through experiment that, by changing the angle of the tap structure, greater than 90% of the tap structure output in can be directed out of the optical fiber in a beam below the tap structure. Thus, the present invention optimizes the tap structure output efficiency.

FIG. 12B is a flow chart of an iterative process of modeling an illumination pattern according to the invention. Steps S1710-S1740 are similar to steps S1610-S1640 of FIG. 12A. In step S1750, it is determined whether the desired illumination pattern has been obtained. If the desired illumination pattern has been obtained, the process ends. If the desired illumination pattern has not been obtained, then the illumination pattern parameters are used (step S1760) and steps S1710-S1740 are repeated.

FIG. 12C is a flow chart of a program for generating tap structures for a particular desired illumination pattern according to the invention. In step S1810, the desired illumination pattern is input. In step S1820, a Fourier transform is performed on the desired illumination pattern. In S1830, the weights of plane waves are determined for the desired illumination pattern. In step S1840, illumination pattern parameters are determined for the desired illumination pattern, and in step S1850 the program outputs the corresponding tap structures.

Again, the above-discussed process for determining illumination pattern parameters to yield an illumination pattern involves modeling of a planar waveguide. However, current computational techniques also allow for modeling of asymmetrical, cylindrical or other waveguides.

An example of the high efficiency lighting that can be achieved using the present invention is discussed below. It should be understood that this discussion is merely exemplary of one application, and should not be construed as limiting. The present invention is also applicable to other applications.

### Illumination Patterns for Hydroponic Plant Lighting

As previously discussed, one application of the present invention may be for the hydroponic growth of plants. A major requirement for the Advanced Life Support System for long distance human space flight is the growth of food crops. Banks of hydroponic crops provide not only much needed diet variety but also serve as part of the water and air recycling systems. For example, 20 m² of leaf crops such as lettuce in a closed loop system will take care of the food needs of 0.5 humans, the water purification of 4 humans and the oxygen of 1 human. High efficiency lighting for such hydroponic farm systems is a necessity. The highest efficiencies to date have been demonstrated by Dynamac Corporation, under contract to NASA, using arrays of red (90%) and blue (10%) light emitting diodes (LEDs). See, G. D. Goins et al., Performance of Salad-type Plants Using Lighting and Nutrient Deliver Concepts Intended for Spaceflight, SAE Transactions-Journal of Aerospace, vol. 107, page 284 (1998); G. D. Goins et al., Life Cycle Experiments with Arabidosis Grown Under Red Light-emitting Diodes (LEDs), Life Support & Biosphere Science, vol. 5, page. 143 1998); and G. D. Goins et al., Photomorphogenesis; Photosynthesis, and Seed Yield of Wheat Plants Grown Under Red Light-emitting Diodes (LEDs) With and Without Supplemental Blue Light, Journal of Experimental Botany, vol. 48, page 1407 (1997), which are hereby incorporated by reference. They have shown that several types of crops including: wheat, lettuce, radishes, and spinach can be successfully grown at photon fluxes of 250 micromoles/m²-s, using these narrow band sources. The use of light sources that preferentially target the chlorophyll absorption system (660-690 nm) with a small amount of blue light (470 nm in the Dynamac experiments) to support photomorphogenesis immediately increases the efficiency of the lighting system as only those photons that are utilized by the plants are supplied. Broadband light sources, in contrast, produce significant amounts of non-red/non-blue photons and, even in the photosynthetically active region (PAR) of 400-700 nm, usually do not exhibit the optimum ratio of red to blue photons. Most plants utilize the red and blue parts of the spectrum more efficiently than the yellow, green and far red portions of the PAR. For example, plants grown with 700 nm (90%) and 470 nm (10%) LEDs produced significantly less food mass per mole of photons than those grown at 660, 670 and 690 nm, all of which yielded approximately the same food mass.

Although LEDs can exhibit relatively high electron to photon conversion efficiencies—approaching 25% in some cases—the Dynamac group has shown that the overall “wallplug” efficiencies are significantly less with measured total efficiencies in the single digits. Losses in the power supplies, cooling systems and control circuitry, in addition to inefficient use of the photons produced by the LED contribute to the decrease in the overall efficiency.

Semiconductor laser diodes (SDLs) have electron to photon conversion efficiencies approximately twice that of LEDs and are, therefore, attractive candidates for highly efficient light sources. Their output is, however, highly directional and inappropriate for plant growth illumination systems. In one embodiment of the invention, high power laser diodes are coupled into a fiber optic distribution system that directs the laser light in a controllable, efficient manner to the growing plants. By changing the depth and geometry of a tap structure in an optical fiber, tapped light can be directed to a wide or narrow cone either above or below the optic fiber. This allows the photon flux on the growing plants to be controlled as well as the illuminated area as the plant grows, as shown, for example, in FIG. 12.

FIG. 13 is a schematic drawing of a hydroponic plant lighting system according to one embodiment of the invention. A frame 100 supports plants 115. The frame may also support optical fibers 110. The optical fibers 110 are provided with tap structures that allow light to be tapped out of the optical fibers 110 in the pattern of a cone 120. Light is provided to the optical fibers via a light source 125, in this example an SDL Array; however, other light sources may be utilized. The hydroponic plant lighting system of FIG. 13 also includes a controller 130 and power supply and cooling device 135.

By using different types of tap structures or by moving the lighting system as the plant grows, the illuminated area can be tailored to match the changing leaf area of the plant. For example, an array of laser diodes in the 660-690 nm range can be coupled into the lighting system. As the plant grows and requires more light, additional laser diodes can be turned on. The small amount of blue light necessary will initially be provided by less efficient doubled laser diodes or blue LEDs, although blue laser diodes are beginning to become available and progress in this area will be monitored closely.

The resulting system provides reliable, efficient light sources coupled to a system for distributing a photon flux to the growing plant that adapts to its size and light needs. The light sources are more efficient and can be clustered to minimize electrical wiring and cooling distribution. The optical “wire” distribution system is intrinsically lower mass than electrical wires to individual light sources. Individual components of such a system have been demonstrated.

The present invention can be used to produce appropriate illumination patterns for the growth of salad components and other crops in the limited space and power resource environment of a long duration manned space flight vessel.

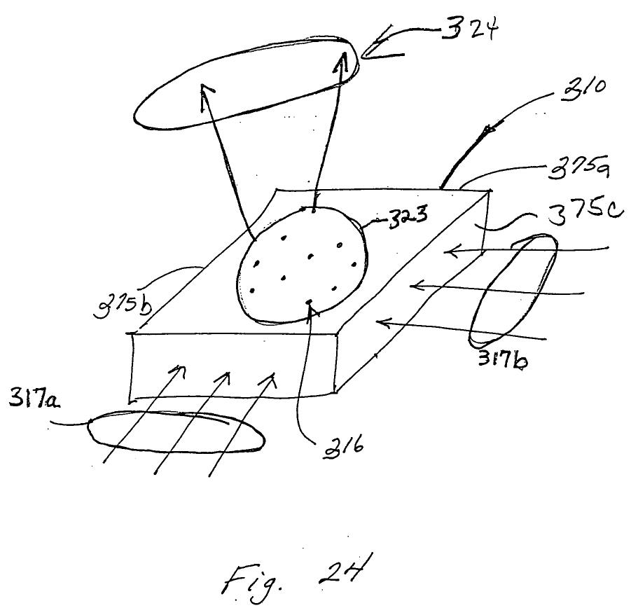

Another model fiber optic illumination system is shown in FIG. 23. Using the data from Dynamac Corporation for lettuce growth, approximately 40 W/ms (approximately 225 μmoles) of red light and 6 W/m² (25 μmoles) of blue light were necessary for food mass production comparable to conventional broad band artificial light sources. Their test of 0.3 m² supported six mature lettuce plants requiring about 2W of red and 0.3 W of blue per plant over an area of approximately 0.05 m²each. Assuming that seedlings and small plants require the same light intensity, only a small fraction of that 2.3 W/plant would be necessary in early growth stages. For example, a 1″ diameter seedling would require only about 1% (0.0005 m²) of the light required for the full grown plant.

Using an array of SDLs coupled into individual fibers, the light necessary for plant growth can be tailored to the size of the plant. Although it is understood that staggered planting utilizes space more efficiently, it is assumed, for purposes of illustration, that a single SDL array and fiber bundle serves 10 plants all planted at the same time. Only the red light sources are considered in this example. One fiber fed by a 300 mW red SDL with tap structures designed to provide 10% of the total power to each plant in a narrow beam profile will provide initial illumination (time ti). As the plant grows, additional higher power SDLs with different fibers and illumination profiles are turned on (t₂) until full growth is achieved at time t₃ with all SDLs turned on, providing 20-30 W total. Significant power savings result from this efficient use of illumination. For salad component plants such as radish, lettuce, and spinach with a roseate growth habit, the radius of the plant increases approximately linearly with time, t, and therefore the leaf area increases as t². Using this simple model, directed lighting would save ⅔ of the energy required for uniform lighting. The system can be automated by placing detectors in the root-shoot plane and turning on more SDLs as leaves obscure the detectors.

### Illumination Sources

The electron to photon conversion efficiencies of LEDs and SDLs have increased significantly in the recent past. Maximum efficiencies of LEDs approach 30% in the infrared while IR SDLs approach 60% efficiency. See, Conference on Lasers and Electro-Optics (CLEO), Baltimore, Md., May 1999, papers CM14 and CM15, which are hereby incorporated by reference. The efficiencies of red LEDs and SDLs are less but have also increased rapidly from their initial values.

Because of the resonant cavity of SDLs, the useful photon production is intrinsically greater than in LEDs where many photons are reabsorbed in the surrounding material, creating an additional heat load. In general the efficiencies of SDLs is about twice that of comparable LEDs. The overall electrical “wallplug” efficiency, which includes power supply and control circuit losses and cooling, is very difficult to measure and compare from one system to another. As mentioned previously, Dynamac Corporation has made careful measurements of 90% red/10% blue LED arrays and finds overall efficiencies of 4-5%. Although it is difficult to compare specific systems, it is clear that, if the electron to photon conversion efficiency of SDLs is higher, there is less waste heat to remove and the overall efficiency, even assuming similar power supply and circuit losses, will be significantly greater. Coupling losses from the SDL to the fiber can be made very small using techniques developed by the fiber optic communication industry.

Commercially available high power red SDLs are currently limited to approximately 500 mW. However, infrared SDLs of more than 2 W are commercially available so that it is reasonable to expect that the power of single red SDLs will continue to increase. Higher power SDL sources are achieved by coupling individual SDLs to optical fibers and creating a fiber optic bundle of up to approximately a millimeter in diameter. Coherent Semiconductor Group has just announced, for example, a 60 W infrared 38 fiber bundle source.

Blue SDLs are relatively new, as are blue LEDs. Efficiencies of both are, therefore, lower than red or infrared. It is expected that the efficiencies of these devices will increase rapidly as material and device fabrication are improved as has been the case for other systems.

The SDL/fiber optic illumination system according to one embodiment of the invention also allows the plant illumination to be tailored to the leaf area of the growing plant. Either by using different fibers with different illumination profiles as the plant leaf area increases or by raising the lightweight grid which hold fibers with a fixed illumination profile, corresponding smaller amounts of energy will be necessary to effectively illuminate early stage plants. In addition, the electrical and cooling systems system serving the SDLs can be consolidated in one area of the biomass production chambers. Lightweight fibers serve as the distribution system for plant growth illumination in much the same way that drip irrigation systems provide water only to the plant root system.

The present invention combines the geometrical and low mass advantages of a fiber optic illumination system with the increased efficiency of semiconductor diode laser (SDL) sources and the ability to cluster power supplies and cooling systems in one area to show proof of concept of a more energy efficient, lower mass illumination system for hydroponic plant growth in space.

The present invention optimizes the fiber optic illumination system. Single tap structures of different angles and depth can be fabricated in high power laser fiber. The fibers currently being used in high power red SDL arrays are approximately the same core diameter as those used in the experiments described above. The illumination profile from the various tap structures coupled to a single red SDL can be measured as a function of distance from the fiber using photodiodes. The light source/root-shoot barrier distance may be, for example, approximately 25 cm, although the data could be extrapolated to other distances. Further, illumination profiles as a function of distance from the fiber can be measured to obtain data similar to that in FIG. 22, i.e., intensity and exit angle, in addition to the divergence angle and the illumination uniformity at various distances.

Because machining a groove in a fiber decreases its structural integrity, a fixture must be provided to hold both single and multiple fibers in order to make tap structure arrays without fiber breakage. Although it is possible to make single or several tap structures in a free space suspended optical fiber without fiber breakage, the more tap structures the more likely an unsupported fiber will break. For example, the optical fibers may be mounted in plastic with only their upper and lower surfaces exposed.

Multiple tap structures may be machined in the supported fibers and the illumination pattern measured. In addition to illumination pattern parameters of tap structure angle, depth and geometry, the spacing of the tap structures effects the illumination pattern of the emitted light. For example, multiple, closely spaced tap structures may be necessary to produce the large area relatively uniform illumination pattern necessary for plant growth near maturity. Plant physiologists can be consulted to determine optimum angles of incidence for illumination at various stages of plant growth. Because it is possible to make tap structures which produce different angles of illumination as shown in FIG. 22, not only intensity but also angle of incidence can be varied to optimize plant growth.

Although it is expected that the desired illumination profiles can be produced by changing the tap geometry and spacing alone, it is also possible to add additional small, lightweight lenses to the illumination system. Further, a lightweight grid carrying the fibers up and down can be moved to change the illuminated area, if necessary.

Blue SDLs can also be added to the system. Such systems are currently very new, expensive and short-lived. A doubled infrared SDL can be substituted as the blue light source. Illumination profiles can be measured as for the red SDL system, although it should not be necessary to do as many experiments as the results with different wavelengths can be predicted using the initial models.

In addition to the measurement of illumination profiles as a function of tap structure geometry and spacing, the profiles and depth of the tap structures can be measured using stylus profilometry. Knowledge of the precise geometry of the tap structures is necessary for correlation of the experimental results with the modeling results. The tap structures can also be examined using optical and electron microscopy. Modeling of the asymmetrical geometry of the tap structure is difficult. The tap structure destroys the cylindrical symmetry of the optical fiber and much more complex modeling systems must be used. The planar waveguide models are useful as an initial model as they produced relatively good agreement with experiment in the prior work. However, they do not provide accurate intensity distributions for the tap structure output.

Three theoretical approaches could be used to predict illumination profiles from multiple taps in fiber: bi-directional beam propagation method (BPM), FDTD, see, K(. Patil, M. S. thesis, Indian Institute of Technology, Kanpur (1995), which is hereby incorporated by reference, and finite element method (FEM).

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method of determining illumination patterns resulting from light passing through one or more tap structures on one or more optical fibers or waveguides, comprising:
selecting illumination pattern parameters for the one or more tap structures;
geometrically modeling the cross section of each of the one or more tap structures using the illumination parameters; and
predicting propagation direction and intensity of the plane waves.

2. The method according to claim 1, wherein geometrically modeling comprises geometrically modeling using a planar waveguide.

3. The method according to claim 1, wherein geometrically modeling comprises geometrically modeling using a cylindrical waveguide.

4. The method of claim 1, further comprising:
determining whether the predetermined illumination pattern has been obtained;
adjusting the illumination parameters if the predetermined illumination pattern has not been obtained; and
repeating the steps of claim 1.

5. An optical fiber or waveguide having a plurality of tap structures designed to output a predetermined illumination pattern using the method of claim 1.

6. An optical fiber or waveguide having a plurality of tap structures designed to output a predetermined illumination pattern using the method of claim 3.
